(19) United States
(12) Patent Application Publication
(10) Pub. No.: US 2013/0147091 A1
(43) Pub. Date: Jun. 13, 2013

(54) VALVE PIN ACTUATOR

(71) Applicant: Denis Babin, Georgetown (CA)

(72) Inventor: Denis Babin, Georgetown (CA)

(73) Assignee: MOLD-MASTERS (2007) LIMITED, Georgetown (CA)

(21) Appl. No.: 13/323,348

(22) Filed: Dec. 12, 2011

(51) Int. Cl. B29C 45/74; B29C 45/23

(52) U.S. Cl. 264/328.15; 425/564

(57) ABSTRACT

A valve pin actuator for an injection molding system includes a housing defining a chamber, the chamber having a nozzle opening portion and a nozzle closing portion. A piston is axially slideable within the chamber between a nozzle open position and a nozzle close position. The piston secures a valve pin to translate axial movements of the piston into axial movements of the pin. The nozzle opening portion of the chamber is configured to receive a first fluid to pressurize the nozzle opening portion to urge the piston towards the nozzle open position. The nozzle closing portion of the chamber is configured to receive a second fluid to pressurize the nozzle closing portion to urge the piston towards the nozzle close position. A fluid passage defined by the piston allows fluid communication between the nozzle opening portion and the nozzle closing portion.

### FIELD OF THE INVENTION

The invention relates generally to an injection molding system and, in particular, to a hot runner system having valve pin actuators.

### BACKGROUND OF THE INVENTION

Valve pin actuators can be used to control the movement of valve pins in a hot runner system. However, the valve pin actuators, used in a hot runner system, can be subjected to conditions that can lead to certain problems. For example, the seals within the valve pin actuators can deteriorate, if not fail, due to exposure to the heat generated by the hot runner system.

There is a need to cool the valve pin actuators.

### BRIEF SUMMARY OF THE INVENTION

According to an aspect of this application, there is provided a valve pin actuator for an injection molding system. The valve pin actuator includes a housing defining a chamber. The chamber includes a nozzle opening portion and a nozzle closing portion. The actuator further includes a piston positioned within the chamber, the piston being axially slideable within the chamber between a nozzle open position and a nozzle close position. The piston secures a pin to translate axial movements of the piston into axial movements of the pin. The nozzle opening portion of the chamber is configured to receive a first fluid to pressurize the nozzle opening portion to urge the piston towards the nozzle open position, and the nozzle closing portion of the chamber is configured to receive a second fluid to pressurize the nozzle closing portion to urge the piston towards the nozzle close position. The actuator further includes a fluid passage defined by the piston. The nozzle opening portion is in fluid communication with the nozzle closing portion via the fluid passage.

In another aspect of this application, a check valve may be positioned within the fluid passage to prevent the second fluid from flowing from the nozzle closing portion into the nozzle opening portion. Accordingly, only the first fluid from the nozzle opening portion may flow through the fluid passage to the nozzle closing portion.

According to another aspect of this application, a method of cooling a valve pin actuator of a hot runner system includes seeping, via a fluid passage defined by a piston of the valve pin actuator, a fluid between a nozzle opening portion a chamber of the valve pin actuator and a nozzle closing portion of the chamber of the valve pin actuator to cool the valve pin actuator.

The method can further include pressurizing the nozzle opening portion of the valve pin actuator with the fluid to urge the piston towards a nozzle open position.

The method can further include restricting the fluid from flowing from the nozzle closing portion of the valve pin actuator to the nozzle opening portion of the valve pin actuator via the fluid passage.

According to another aspect of this application a hot runner system includes a manifold for distributing a melt stream of moldable material, a plurality of nozzles coupled to the manifold to inject the melt into mold cavities, and a plurality of valve pins. Each valve pin is disposed within a melt channel of a respective nozzle. Each of the plurality of valve pins is coupled to a valve pin actuator. The valve pin actuator includes a housing defining a chamber having a nozzle opening portion and a nozzle closing portion. A piston is positioned within the chamber dividing the chamber into the nozzle opening portion and the nozzle closing portion. The piston is axially slideable within the chamber between a nozzle open position and a nozzle close position. The valve pin is secured to the piston such that axial movements of the piston are translated into axial movements of the valve pin. The nozzle opening portion of the chamber is configured to receive a first fluid to pressurize the nozzle opening portion to urge the piston towards the nozzle open position, and the nozzle closing portion of the chamber is configured to receive a second fluid to pressurize the nozzle closing portion to urge the piston towards the nozzle close position. A fluid passage is defined by the piston. The nozzle opening portion is in fluid communication with the nozzle closing portion via the fluid passage.

In another aspect of this application, a check valve may be positioned within the fluid passage to prevent the second fluid from flowing from the nozzle closing portion into the nozzle opening portion. The check valve may be a ball or a check pin.

In another aspect of the application a porous insert may be positioned within the fluid passage to reduce the rate of flow of the fluid through the fluid passage.

### BRIEF DESCRIPTION OF THE DRAWINGS

The foregoing and other features and advantages of the invention will be apparent from the following description of embodiments thereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is a front sectional view of a hot half of an injection molding system having a valve pin actuator in accordance with an embodiment hereof.

FIG. 2 is an enlarged view of a portion of the system shown in FIG. 1 with a section of a forward portion thereof taken along line 2-2 of FIG. 1.

FIG. 3 is a schematic diagram showing the valve pin actuator of FIG. 1 in a nozzle open position.

FIG. 4 is a schematic diagram showing the valve pin actuator of FIG. 1 in a nozzle close position.

FIG. 5 is a sectional view of the valve pin actuator of FIG. 1 taken along line 2-2 of FIG. 1, according to another embodiment of the present application.

FIG. 6 is a sectional view of the valve pin actuator of FIG. 1 taken along line 2-2 of FIG. 1, according to yet another embodiment of the present application.

FIG. 7 is a block diagram of a method to cool a piston of a valve pin actuator according to an embodiment of the present application.

FIG. 8 is a schematic diagram showing the direction of flow of the working fluid during the performance of a block of the method of FIG. 7.

FIG. 9 is a block diagram of a method to cool a piston of a valve pin actuator according to another embodiment of the present application.

FIG. 10 is a schematic diagram showing the direction of flow of the working fluid during the performance of a block of the method of FIG. 9.

FIG. 11 is a side sectional view of a portion of an example hot runner system with its actuator not coupled directly to the manifold.

### DETAILED DESCRIPTION OF THE INVENTION

Specific embodiments of the present invention are now described with reference to the figures. The following detailed description is merely exemplary in nature and is not intended to limit the invention or the application and uses of the invention. Furthermore, there is no intention to be bound by any expressed or implied theory presented in the preceding technical field, background, brief summary or the following detailed description. In the following description, “downstream” is used with reference to the direction of mold material flow from an injection unit of an injection molding machine to a mold cavity of a mold of an injection molding system, and also with reference to the order of components, or features thereof, through which the mold material flows from the injection unit to the mold cavity, whereas “upstream” is used with reference to the opposite direction. Similarly, “forward” is used with reference to a direction towards a parting line of a mold, whereas “rearward” is used with reference to a direction away from the parting line.

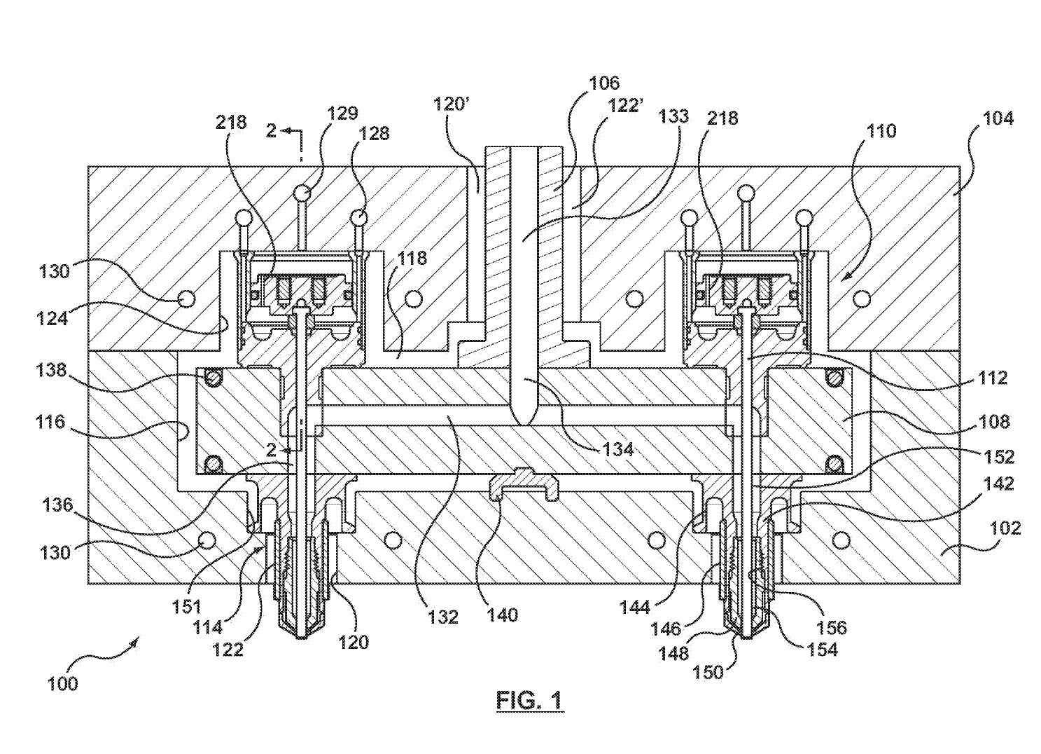

FIG. 1 is a front sectional view of a hot half of a hot runner injection molding system 100 (referred to as “hot runner system 100” for the remainder of this application) in accordance with an embodiment of the present invention. Hot runner system 100 includes a manifold plate 102, a back plate 104, an inlet extension 106, a manifold 108, valve pin actuators 110, valve pins 112 and a pair of valve-gated nozzles 114. In the embodiment of FIG. 1, hot runner system 100 is depicted having only two valve-gated nozzles 114 and a single manifold by way of example and not limitation. In an alternate embodiment, hot runner system 100 may include more or fewer valve-gated nozzles or additional manifolds, or both. Further, hot runner system 100 can include additional components such as, for example, additional mold plates, insulator plates, alignment dowels, bolts, and lifting holes, among others without departing from the scope hereof.

Manifold plate 102 is provided with a pocket 116 for housing manifold 108. Back plate 104 together with pocket 116 define an air space 118 surrounding manifold 108 for insulating back plate 104 and manifold plate 102 from manifold 108 when manifold 108 is heated. Similarly, manifold plate 102 and back plate 104 are provided with clearance bores 120, 120′ for defining respective insulative air spaces 122, 122′ around each valve-gated nozzle 114 and inlet extension 106, respectively.

Back plate 104 is provided with actuator pockets 124 for accommodating valve pin actuators 110. Additionally, back plate 104 is provided with an open fluid conduit 128 and a close fluid conduit 129 for delivering a supply of working fluid, i.e., a pneumatic type fluid, to respective valve pin actuators 110. Back plate 104 and manifold plate 102 are also provided with fluid channels 130 through which a flow of cooling fluid is circulated in order to maintain hot runner system 100 at a requisite processing set point as would be understood by one of ordinary skill in the art. Bolts (not shown) are generally used to secure back plate 104 and manifold plate 102 together. The configuration of back plate 104 and manifold plate 102 in the embodiment of FIG. 1 is shown by way of example and not limitation. In another embodiment (not shown), back plate 104 may not include actuator pockets, but instead may be separated from manifold plate 102 by an intermediate spacer plate having a thickness that corresponds to the depth of actuator pockets 124 and bores extending there through for accommodating the actuators.

Manifold 108 defines a manifold channel 132 for distributing a stream of moldable material received from an injection molding machine (not shown) via a melt channel 133 of inlet extension 106 through a manifold inlet 134 to a plurality of manifold outlets 136. In order to maintain the stream of moldable material at a processing temperature, manifold 108 is provided with a manifold heater 138 such as, for example, the insulated resistance wire shown. Manifold 108 is also provided with a manifold locator 140, which serves to locate manifold 108 in manifold plate 102 with respect to valve-gated nozzles 114.

In the embodiment shown in FIG. 1, each valve-gated nozzle 114 includes inter alia a nozzle body 142, a nozzle flange 144, a nozzle heater 146, a nozzle tip 148 and a nozzle tip insulator 150. Nozzle flanges 144 locate valve-gated nozzles 114 in a locating bore 151 provided in manifold plate 102 and, in the current embodiment further serve to support manifold 108 within pocket 116. Each valve-gated nozzle 114 defines a nozzle channel 152 which is in fluid communication at an upstream end with manifold channel 132 via a respective manifold outlet 136 and at a downstream end with a nozzle tip channel 154 for delivering a stream of moldable material to mold cavities (not shown) via mold gates (also not shown). Nozzle heater 146 may be a removable band heater. In alternate embodiments hereof, other nozzle heaters may be utilized, for example, an embedded insulated resistance wire (not shown), without departing from the scope of the present invention. Nozzle tip 148 is generally manufactured from a thermally conductive material, whereas nozzle tip insulator 150 is generally manufactured from a less thermally conductive material than nozzle tip 148. In the current embodiment, nozzle tip 148 is removably coupled to a downstream end of valve-gated nozzle 114 by a threaded connection 156. In an alternate embodiment (not shown), nozzle tip 148 may be removably coupled to valve-gated nozzle 114 by a separate tip retainer which may also serve to locate a downstream end of valve-gated nozzle 114 with respect to its mold gate, as would be understood by one of ordinary skill in the art.

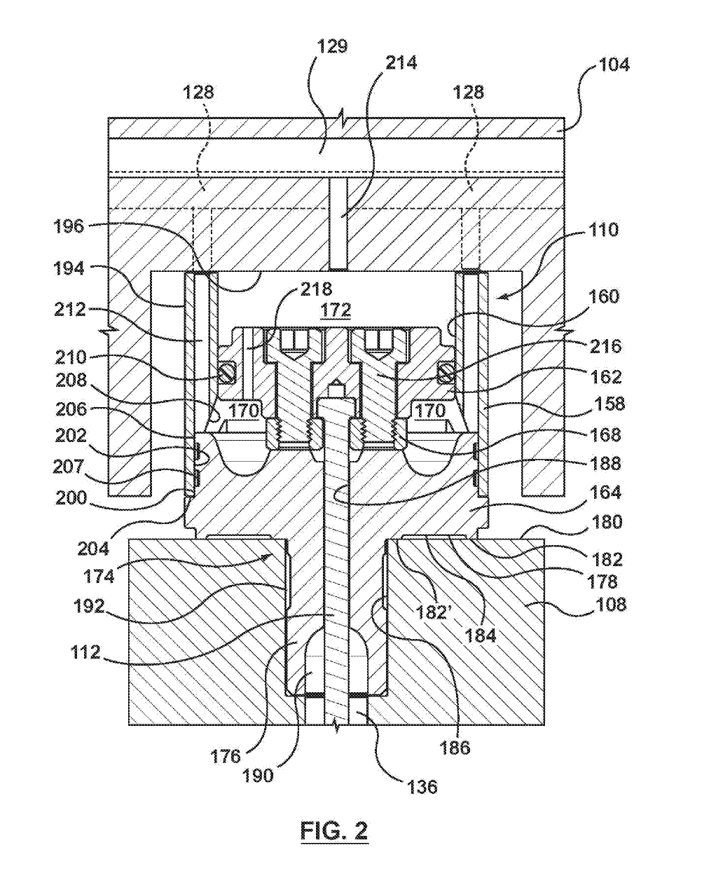

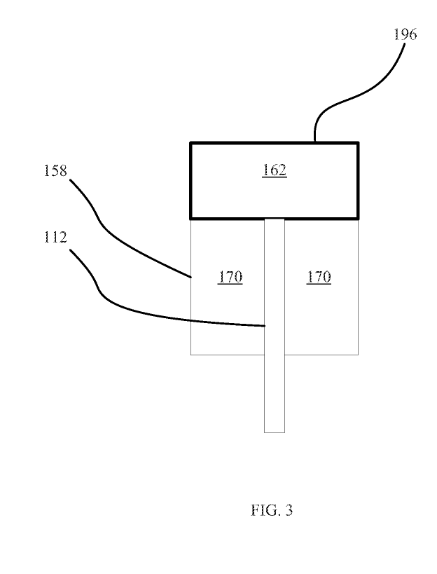

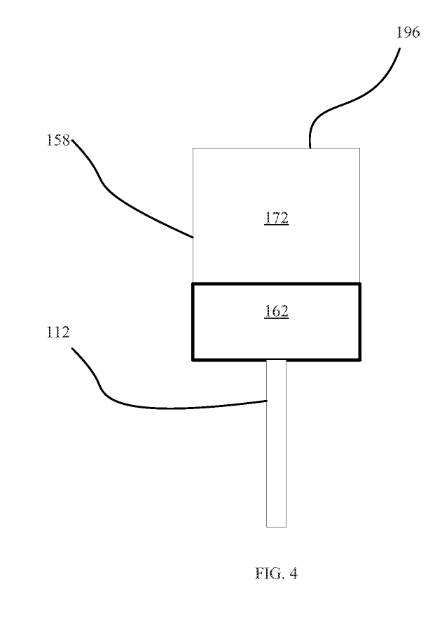

FIG. 2 is an enlarged view of a portion of the system shown in FIG. 1 depicting one of the valve pin actuators 110, with a section of a forward portion thereof taken along line 2-2 of FIG. 1. Valve pin actuator 110 comprises a housing 158 defining a chamber 160, a piston 162 positioned within the chamber 160, and a base member 164. Valve pin 112 is secured to piston 162, by a valve pin retainer 168, to translate axial movements of piston 162 into axial movements of valve pin 112. Chamber 160 includes a nozzle opening portion 170 and a nozzle closing portion 172. Piston 162 is positioned within chamber 160 and is axially slideable within chamber 160 between a nozzle open position (see FIG. 3, which is a schematic diagram of valve pin actuator 110 in a nozzle open position) and a nozzle close position (see FIG. 4, which is a schematic diagram of valve pin actuator 110 in a nozzle close position). Piston 162 divides chamber 160 into the nozzle opening portion 170 and the nozzle closing portion 172. Thus, in the embodiment shown, nozzle opening portion 170 of chamber 160 is defined by perimeter walls 194, a downstream surface of piston 162 and an upstream surface of base member 164. Similarly, nozzle closing portion 172 of chamber 160 is defined by perimeter walls 194, a downstream surface of an upstream end wall 196 (described below), and an upstream surface of piston 162.

Base member 164 extends outwardly from a locating portion 174, which in the current embodiment is in the form of a spigot 176 that extends in a forward direction from a downstream surface 178 of base member 164, wherein downstream surface 178 contacts an upstream surface 180 of manifold 108 at outer and inner stand-offs 182, 182′. Outer and inner stand-offs 182, 182′ define an air gap 184 therebetween to reduce the heat transfer between manifold 108 and base member 164.

Spigot 176 locates base member 164 and subsequently the remainder of valve pin actuator 110 within a locating bore 186 of manifold 108 that extends rearward from manifold outlet 136 to upstream surface 180 of manifold 108. A guide bore 188 sized to slidably receive valve pin 112 extends through base member 164 and spigot 176 from an upstream surface of base member 164 to a diverting channel 190 provided in spigot 176. Diverting channel 190 is shaped to provide a 90 degree redirection of the melt stream from melt channel 133 to manifold outlet 136. Spigot 176 also includes an area of reduced diameter for defining a spigot air gap 192 between spigot 176 and manifold 108. Similar to air gap 184 described above, spigot air gap 192 serves to reduce the contact area between manifold 108 and spigot 176 to reduce heat transfer there between. Housing 158 includes a perimeter wall 194, an upstream end wall 196 and a downstream end wall defining chamber 160. In the embodiment depicted by FIGS. 1 and 2, base member 164 is the downstream end wall. A locating shoulder 200 is provided on an outside diameter of base member 164 for locating and engaging perimeter wall 194 at a locating diameter 202 adjacent to a forward end 204 of perimeter wall 194. Similar to spigot 176, a radial face 206 of locating shoulder 200 is provided with areas of reduced diameter to define air gaps 207 between radial face 206 and locating diameter 202 to reduce the contact area between base member 164 and perimeter wall 194 for reducing heat transfer there between. In an embodiment, an O-ring (not shown) may be provided between radial face 206 and locating diameter 202 to aid in creating a seal between base member 164 and perimeter wall 194.

Perimeter wall 194 is removably coupled to base member 164 at an interface between forward end 204 and locating shoulder 200. When unheated and not installed within hot runner system 100, perimeter wall 194 and base member 164 are formed to slide apart at their interface. However, when hot runner system 100 is heated to an operating temperature, perimeter wall 194 and base member 164 are held together due to thermal expansion of the parts. Perimeter wall 194 is sized to slidably engage piston 162, and tapers outward adjacent forward end 204 to create a lead-in surface 208 to facilitate assembly of housing 158 with piston 162, specifically to facilitate alignment of piston 162 and a sealing member 210 provided thereon within housing 158. In the present embodiment, sealing member 210 is in the form of a metal O-ring which serves to create a seal between piston 162 and perimeter wall 194 and to define nozzle opening portion 170 and nozzle closing portion 172 as described above.

A plurality of open actuation conduits 212 extends through perimeter wall 194 from upstream end wall 196 to lead-in surface 208. Each open actuation conduit 212 is in fluid communication with open fluid channel 128 for delivering a pressurized fluid to nozzle opening portion 170 for actuating piston 162 and valve pin 112 that is connected thereto rearward to the nozzle open position (see FIG. 3), which allows the stream of moldable material to flow through the mold gate (not shown) and into the mold cavity (also not shown). Close fluid conduit 214 in back plate 104 permits the passage of a fluid to pressurize nozzle closing portion 172 for actuating piston 162 and valve pin 112 that is connected thereto forward to the nozzle close position (see FIG. 4), which prevents the melt stream of moldable material from flowing through the mold gate (not shown) and into the mold cavity (also not shown). As shown in FIG. 2, valve pin 112 extends through valve pin retainer 168, which is removably coupled to piston 162 by a pair of socket head cap screws 216. In alternate embodiments hereof, other connections between piston 162 and valve pin 112 are contemplated without departing from the scope of the present invention as would be understood by one of ordinary skill in the art.

Coupling valve pin actuators 110 directly to manifold 108 has the advantage of preserving the alignment of valve pin actuators 110 with manifold 108 when manifold 108 thermally expands or contracts. When manifold 108 thermally expands or contracts, valve pin actuators 110 shift with manifold 108 thereby preserving their alignment with manifold 108. However, the heat from manifold 108 can cause certain components (e.g., sealing member 210) of valve pin actuator 110 to fail or cause other problems such as the degradation of the plastic that can accumulate in air space 118 at the upstream portion of base member 164.

Cooling actuator 110 can help alleviate the above-described problems. To reduce the temperature of actuator 110, according to the embodiment depicted in FIGS. 1 and 2, piston 162 defines a fluid passage 218 therethrough between nozzle opening portion 170 and nozzle closing portion 172 (more detail of the use of fluid passage 218 will be provided below). That is, nozzle opening portion 170 is in fluid communication with nozzle closing portion 172 via fluid passage 218.

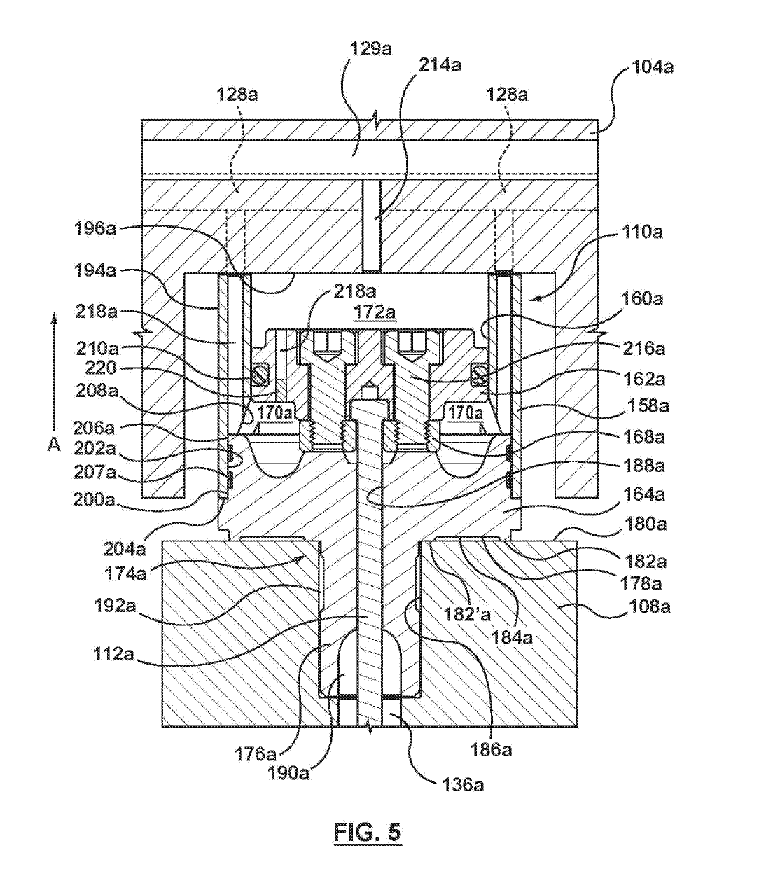

Referring to FIG. 5, a valve pin actuator in accordance with another embodiment is indicated generally at 110a. Valve pin actuator 110a is substantially the same as valve pin actuator 110 and like elements of valve pin actuator 110a bear the same reference characters, but are followed by the suffix “a”. However, unlike valve pin actuator 110, valve pin actuator 110a includes a check valve 220 positioned within fluid passage 218a to allow fluid to flow only in the direction (as indicated by arrow A) from nozzle opening portion 170a to nozzle closing portion 172a. Check valve 220 may be a ball check valve or a check pin, or other check valves known to those of ordinary skill in the art.

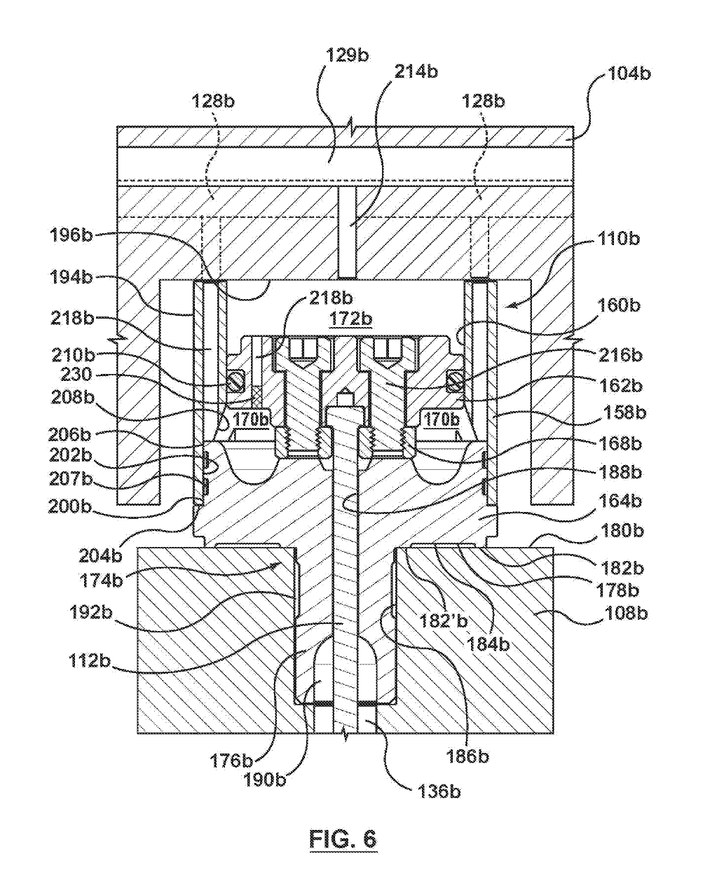

Referring to FIG. 6, a valve pin actuator in accordance with another embodiment is indicated generally at 110b. Valve pin actuator 110b is substantially the same as valve pin actuator 110 and like elements of valve pin actuator 110b bear the same reference characters, but are followed by the suffix “b”. However, unlike valve pin actuator 110, valve pin actuator 110b includes a porous insert 230 positioned within fluid passage 218b to reduce the rate of flow of the working fluid through fluid passage 218b. Advantageously, porous insert 230 can be used to reduce the flow rate through fluid passage 218 without reducing the diameter of fluid passage 218. For example, when the diameter of fluid passage 218 is at a desired size but the flow rate through fluid passage 218 is still above a desired threshold, porous insert 230 can reduce the flow rate through fluid passage 218 to the desired threshold (reference numeral 218 is used generically to include fluid passage 218, 218a, or 218b).

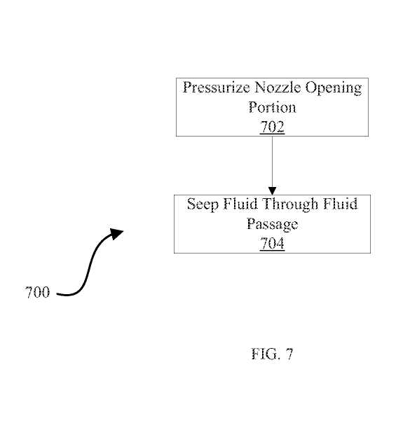

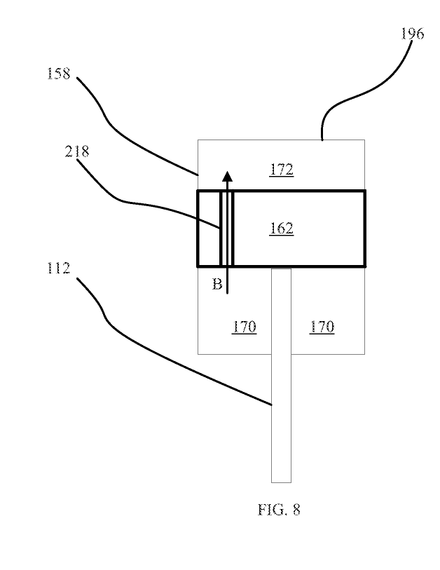

FIG. 7 depicts a method of cooling valve pin actuator 110, according to an embodiment, generally indicated as method 700. Block 702 comprises pressurizing nozzle opening portion 170 with a working fluid. For example, the working fluid can be delivered from open fluid conduit 128 to nozzle opening portion 170 via open actuation conduits 212 to urge piston 162 towards the nozzle opening position. Block 704 comprises seeping the working fluid through fluid passage 218. For example, as the working fluid pressurizes nozzle opening portion 170, the working fluid can seep through fluid passage 218 to nozzle closing portion 172. FIG. 8 depicts a schematic diagram of the direction of flow (as indicated by arrow B) of working fluid during the performance of block 704. As the working fluid moves from nozzle opening portion 170 into fluid passage 218, the working fluid can carry away some of the heat from base member 164. Because base member 164 contacts perimeter walls 194, cooling base member 164 by seeping working fluid, as described above, cools perimeter wall 194, thereby cooling sealing member 210 disposed between perimeter wall 194 and piston 162. Method 700 can also be performed using actuator 110a. Check valve 220 can be selected based on characteristics that would allow the working fluid to pass through fluid passage 218a only if the pressure of the working fluid exceeds a desired threshold so that the pressure from the working fluid can first be used to lift piston 162a until the pressure from the working fluid exceeds the desired threshold, at which point, the working fluid continues to lift piston 162a while some of the working fluid seeps through check valve 220.

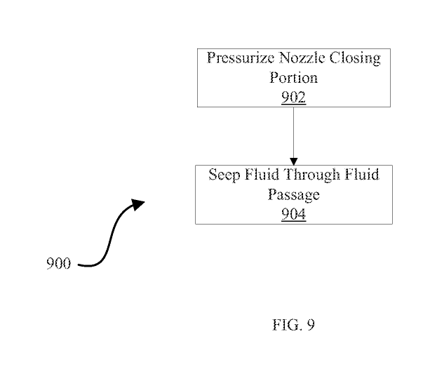

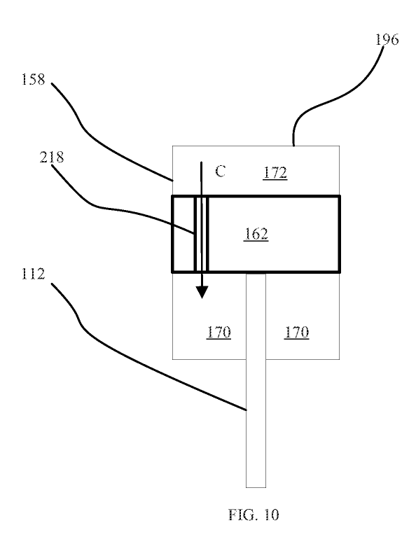

FIG. 9 depicts a method of cooling valve pin actuator 110, according to another embodiment, generally indicated as method 900. Block 902 comprises pressurizing nozzle closing portion 172 with a working fluid. For example, the working fluid can be delivered from close fluid conduit 129 to nozzle closing portion 172 via close actuation conduit 214 to urge piston 162 towards the nozzle closing position. Block 904 comprises seeping the working fluid through fluid passage 218. For example, as the working fluid pressurizes nozzle closing portion 172, the working fluid can seep through fluid passage 218 to nozzle opening portion 170. FIG. 10 depicts a schematic diagram of the direction of flow (as indicated by arrow C) of the working fluid during the performance of block 904. As the working fluid moves from nozzle closing portion 172 into fluid passage 218, into nozzle opening portion 170, and out of nozzle opening portion 170 via open actuation conduit 212, the working fluid can carry away some of the heat from base member 164, thereby cooling valve pin actuator 110 as described above.

Methods 700 and 900 can also be performed using actuator 110b.

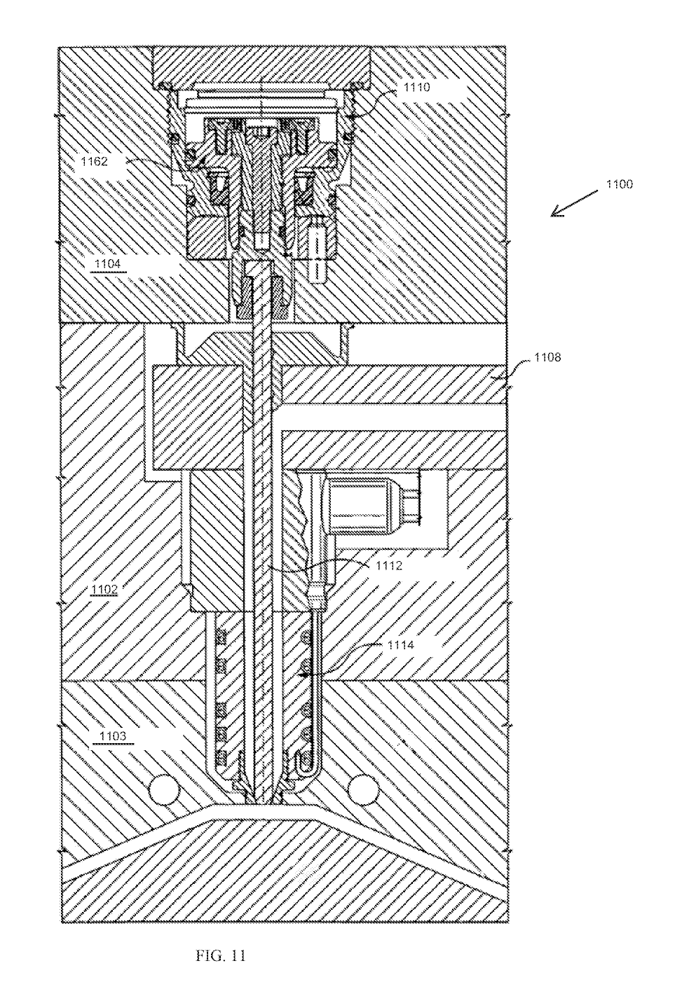

While various embodiments according to the present invention have been described above, it should be understood that they have been presented by way of illustration and example only, and not limitation. It will be apparent to persons skilled in the relevant art that various changes in form and detail can be made therein without departing from the scope of the invention. For example, the solution provided by the present application can be applied to actuators directly couple to the manifold (see FIG. 1) or indirectly coupled to the manifold (see FIG. 11). FIG. 11 depicts a side sectional view of a portion of an example hot runner system 1100 including a manifold plate 1102, a back plate 1104, a mold plate 1103, a manifold 1108, and a nozzle 1114. A valve pin 1112 is actuated by a valve pin actuator 1110 to open and close a mold gate leading to a mold cavity. The valve pin actuator of FIG. 11 is not coupled directly to the manifold 1108. A piston 1162 of actuator 1110 depicted by FIG. 11 can define a fluid passage to be used to cool the valve pin actuator in a manner similar to that described above. As yet another example of a variation that is within the scope of this application, the number of fluid passages (218, 218a, 218b) can be one or more than one. As yet another example, the locations of fluid passages (218, 218a, 218b), check valve 220, and porous insert 230 can vary depending on factors such as the application and material of the components of the hot runner system or of the articles being molded. As yet another example, the diameter of fluid passages (218, 218a, 218b) can vary depending on factors such as the application and material of the components of the hot runner system or of the articles being molded. Thus, the breadth and scope of the present invention should not be limited by the above-described exemplary embodiments, but should be defined only in accordance with the appended claims and their equivalents. It will also be understood that each feature of each embodiment discussed herein, and of each reference cited herein, may be used in combination with the features of any other embodiment.

What is claimed is:

1. A valve pin actuator for an injection molding system, the valve pin actuator comprising:
a housing defining a chamber, the chamber having a nozzle opening portion and a nozzle closing portion;
a piston positioned within the chamber, the piston axially slideable within the chamber between a nozzle open position and a nozzle close position, the piston for securing a pin to translate axial movements of the piston into axial movements of the pin, the nozzle opening portion configured to receive a first fluid to pressurize the nozzle opening portion to urge the piston towards the nozzle open position, the nozzle closing portion configured to receive a second fluid to pressurize the nozzle closing portion to urge the piston towards the nozzle close position; and
a fluid passage defined by the piston, wherein the nozzle opening portion is in fluid communication with the nozzle closing portion via the fluid passage.

2. The valve pin actuator of claim 1 further comprising a check valve positioned within the fluid passage to prevent the second fluid from flowing from the nozzle closing portion into the nozzle opening portion.

3. The valve pin actuator of claim 2 wherein the check valve comprises a ball.

4. The valve pin actuator of claim 2 wherein the check valve comprises a check pin.

5. The valve pin actuator of claim 1 further comprising a porous insert positioned within the fluid passage.

6. The valve pin actuator of claim 1, wherein the piston divides the chamber into the nozzle opening portion and the nozzle closing portion such that the nozzle opening portion is defined by the housing and a downstream surface of the piston and the nozzle closing portion is defined by the housing and an upstream surface of the piston.

7. A method of cooling a valve pin actuator of a hot runner system, the method comprising the step of:
seeping, via a fluid passage defined by a piston of the valve pin actuator, a fluid between a nozzle opening portion of the valve pin actuator and a nozzle closing portion of the valve pin actuator.

8. The method of claim 7 further comprising pressurizing the nozzle opening portion of the valve pin actuator with the fluid to urge the piston towards a nozzle open position.

9. The method of claim 8 further comprising restricting the fluid from flowing from the nozzle closing portion of the valve pin actuator to the nozzle opening portion of the valve pin actuator through the fluid passage.

10. The method of claim 7 further comprising restricting the flow rate of the fluid through the fluid passage through a porous insert disposed within the fluid passage.

11. A hot runner system comprising:
a manifold for distributing a melt stream of moldable material;
a plurality of nozzles coupled to the manifold to inject the melt into mold cavities; and
a plurality of valve pins, each valve pin disposed within a melt channel of a respective nozzle, each of the plurality of valve pins coupled to a valve pin actuator, each valve pin actuator including:
a housing defining a chamber, the chamber having a nozzle opening portion and a nozzle closing portion;
a piston positioned within the chamber, the piston axially slideable within the chamber between a nozzle open position and a nozzle close position, the valve pin secured to the piston to translate axial movements of the piston into axial movements of the valve pin, the nozzle opening portion configured to receive a first fluid to pressurize the nozzle opening portion to urge the piston towards the nozzle open position, the nozzle closing portion configured to receive a second fluid to pressurize the nozzle closing portion to urge the piston towards the nozzle close position; and
a fluid passage defined by the piston, wherein the nozzle opening portion is in fluid communication with the nozzle closing portion via the fluid passage.

12. The hot runner system of claim 11 further comprising a check valve positioned within the fluid passage to prevent the second fluid from flowing from the nozzle closing portion into the nozzle opening portion.

13. The hot runner system of claim 12 wherein the check valve comprises a ball.

14. The hot runner system of claim 12 wherein the check valve comprises a check pin.

15. The hot runner system of claim 11 further comprising a porous insert positioned within the fluid passage to control the flow rate of the first fluid or second fluid flowing through the fluid passage.

16. The hot runner system of claim 11, wherein the piston divides the chamber into the nozzle opening portion and the nozzle closing portion such that the nozzle opening portion is defined by the housing and a downstream surface of the piston and the nozzle closing portion is defined by the housing and an upstream surface of the piston
